(19) United States
(12) Patent Application Publication
(10) Pub. No.: US 2025/0265768 A1
(43) Pub. Date: Aug. 21, 2025

(54) IMAGE GENERATION DEVICE, IMAGE GENERATION METHOD, AND STORAGE MEDIUM

(71) Applicant: CANON KABUSHIKI KAISHA, Tokyo (JP)

(72) Inventor: Yoshiki IWAKIRI, Kanagawa (JP)

(21) Appl. No.: 19/044,707

(22) Filed: Feb. 4, 2025

(30) Foreign Application Priority Data
Feb. 19, 2024 (JP) 2024-023037

(51) Int. Cl. G06T 15/20; G06T 17/00

(52) U.S. Cl. CPC G06T 15/20; G06T 17/00; G06T 2200/08

(57) ABSTRACT

An image generation device obtains a plurality of first three-dimensional (3D) models, of corresponding ones of a plurality of subjects, generated through a first method on the basis of shooting a predetermined region in which the plurality of subjects are present, and a second 3D model that is based on posture information of a specific subject, among the plurality of subjects, present in the predetermined region during the shooting, the second 3D model corresponding to the specific subject and being generated through a second method different from the first method, and outputs a virtual viewpoint image generated on the basis of the first 3D model of a subject, among the plurality of subjects, that is different from the specific subject, and the second 3D model corresponding to the specific subject.

### BACKGROUND

### Field of the Disclosure

The present disclosure relates to a technique for generating a virtual viewpoint image using a plurality of cameras.

### Description of the Related Art

A technology called “volumetric capture”, in which a three-dimensional (3D) model of a subject can be generated from an image shot using a plurality of image capturing devices, is attracting attention. The generated 3D model of the subject is arranged in a virtual space the reproduces (or imitates) the shooting environment of the subject, and is observed using a virtual camera that can be operated in the virtual space. By using the virtual camera, in which a viewpoint position, gaze direction, and the like can be set freely in the virtual space, an image can be observed as if the subject had been shot by a physical camera in a real shooting environment. An image observed through a virtual camera is called a “virtual viewpoint image”. The virtual viewpoint image is obtained by specifying a desired viewpoint and angle of view in the virtual space, and it is therefore possible to reproduce an image which would be difficult to actually shoot using a physical camera. A technique called “motion capture” is also used as a shooting method for generating a 3D model. With this technique, a 3D model is generated by obtaining skeleton information of a subject that has been shot and adding a predetermined computer graphic (CG) model to the skeleton information.

Japanese Patent Laid-Open No. 2022-060058 discloses a technique for generating a single virtual viewpoint image by combining 3D models generated using a common volumetric capture method in a plurality of different spaces that are physically separate, such as a stadium and a studio. For example, a part of the 3D model obtained by shooting in one of the spaces is arranged in another space, and a virtual viewpoint image in that space is generated. However, with this technique, shooting is performed in a plurality of spaces that are different from each other, and it is therefore not possible to sufficiently link the positional relationships, movements, and the like of the subjects present in each of the plurality of spaces. Accordingly, when a plurality of 3D models are generated in different spaces and a single virtual viewpoint image is generated by combining those 3D models, the generated virtual viewpoint image may produce a sense of unnaturalness.

### SUMMARY

The present disclosure provides a technique for generating a desired virtual viewpoint image while linking subjects sufficiently.

An image generation device according to one aspect of the present disclosure includes: one or more processors; and one or more memories that store a computer-readable instruction for causing, when executed by the one or more processors, the one or more processors to: obtain (i) a plurality of first three-dimensional (3D) models, of corresponding ones of a plurality of subjects, generated through a first method on the basis of shooting a predetermined region in which the plurality of subjects are present, and (ii) a second 3D model that is based on posture information of a specific subject, among the plurality of subjects, present in the predetermined region during the shooting, the second 3D model corresponding to the specific subject and being generated through a second method different from the first method; and output a virtual viewpoint image generated on the basis of (i) the first 3D model of a subject, among the plurality of subjects, that is different from the specific subject, and (ii) the second 3D model corresponding to the specific subject.

Further features of the present disclosure will become apparent from the following description of exemplary embodiments with reference to the attached drawings.

### BRIEF DESCRIPTION OF THE DRAWINGS

FIG. 1 is a diagram illustrating an example of the configuration of an image forming system.

FIG. 2 is a diagram illustrating an example of the arrangement of cameras and sensors.

FIG. 3 is a diagram illustrating an example of the hardware configuration of a rendering device.

FIG. 4 is a diagram illustrating an example of the functional configuration of each of apparatuses in the system.

FIG. 5 is a diagram illustrating an example of data to be recorded.

FIG. 6 is a diagram illustrating an example of a bounding box.

FIG. 7 is a diagram illustrating an example of the flow of processing for generating a virtual viewpoint image.

FIG. 8 is a diagram illustrating an example of a virtual viewpoint image that is output.

FIG. 9 is a diagram illustrating another example of the functional configuration of each of apparatuses in the system.

FIG. 10 is a diagram illustrating another example of data to be recorded.

FIG. 11 is a diagram illustrating an example of the flow of processing in tracking control.

FIG. 12 is a diagram illustrating another example of the flow of processing for generating a virtual viewpoint image.

FIGS. 13A to 13C are diagrams illustrating an example of a virtual viewpoint image that is output.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to a disclosure that requires all such features, and multiple such features may be combined as appropriate. Furthermore, in the attached drawings, the same reference numerals are given to the same or similar configurations, and redundant description thereof is omitted.

The following will describe a method for generating a plurality of three-dimensional (3D) models using two methods, namely volumetric capture and motion capture, and combining the 3D models to generate a single virtual viewpoint image. In such a system, a first 3D model, which is generated through the volumetric capture method, and a second 3D model, in which a predetermined CG model is added to a bone model obtained through the motion capture method, can be made to coexist in a single virtual space. “CG” is an acronym for “computer graphics”. This makes it possible to generate appealing content in which the first 3D model, which represents a subject realistically, and the second 3D model, which is virtual, move together. The CG model may be an avatar or the like, for example. The CG model is used in a plurality of scenes, and by linking the CG model with the bone model, the shape of the CG model is deformed, and the second 3D model that is suitable for the scene is generated. Although an example will be described in which the CG model is generated only by a computer without involving shooting a subject in a real space, the present disclosure is not limited thereto. A model generated by shooting a subject in real space with a plurality of cameras using a photogrammetry technique, or a model in which a model generated in this manner is further processed, may be used instead of a CG model. The second 3D model may be generated by linking such a model with a bone model.

In the present embodiment, the two methods of volumetric capture and motion capture are used to simultaneously shoot a single space in order to reduce a sense of unnaturalness in a virtual viewpoint image generated in this manner. Two or more subjects are present in the one space, and a 3D model of the two or more subjects is generated through the volumetric capture method, whereas a 3D model of some of the subjects is generated through the motion capture method. Because the plurality of subjects for which the 3D models are generated using the plurality of methods are present in a common predetermined region, the plurality of subjects can move in tandem while communicating with each other. At this time, when, for example the 3D model of a single subject is generated through both the volumetric capture and motion capture methods, a plurality of 3D models will be present at a position which overlaps spatially, which may cause a sense of unnaturalness in the generated virtual viewpoint image. The present embodiment therefore provides a technique for reducing such a sense of unnaturalness.

### System Configuration

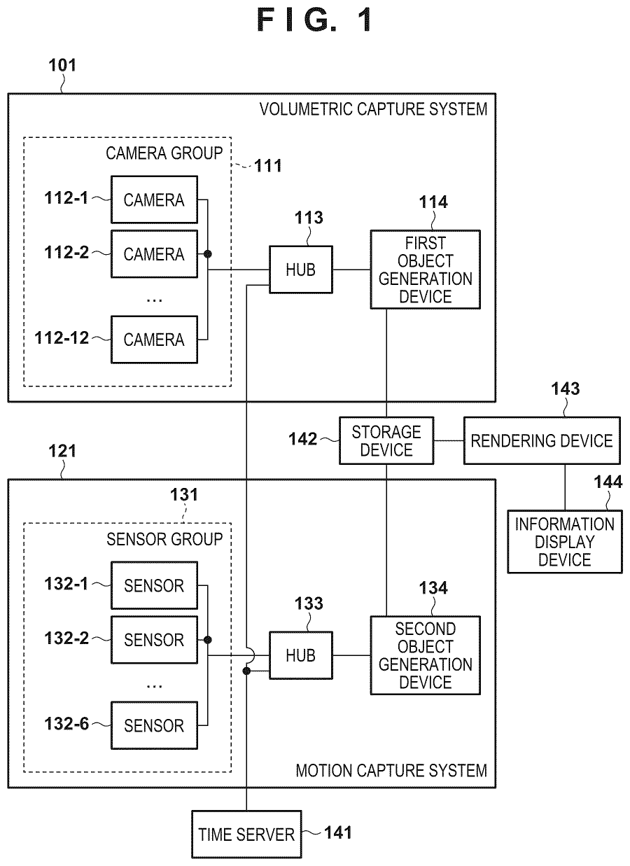

FIG. 1 illustrates an example of the configuration of an image generation system that generates a virtual viewpoint image, according to the present embodiment. The image generation system according to the present embodiment is configured including two shooting systems, namely a volumetric capture system 101 and a motion capture system 121. The volumetric capture system 101 shoots images for generating a 3D model of a subject through the volumetric capture method, and the motion capture system 121 shoots images for generating a bone model of the subject using the motion capture method. The image generation system further includes a time server 141, a storage device 142, a rendering device 143, and an information display device 144.

The time server 141 outputs a time code (time information) to the volumetric capture system 101 and the motion capture system 121. In other words, the volumetric capture system 101 and the motion capture system 121 can operate in synchronization using the time code output from the time server 141. In each of the volumetric capture system 101 and the motion capture system 121, the same time code is associated with a 3D model generated on the basis of data shot at the same time.

The volumetric capture system 101 includes a camera group 111 including cameras 112-1 to 112-12, a hub 113, and a first object generation device 114. The cameras 112-1 to 112-12 belonging to the camera group 111 are arranged so as to surround a subject. Each of the cameras 112-1 to 112-12 obtains a two-dimensional (2D) image through shooting. A multi-viewpoint image is obtained by the cameras 112-1 to 112-12 shooting at a timing that is synchronized. The 2D images shot by the plurality of cameras 112-1 to 112-12 are provided to the first object generation device 114 via the hub 113 along with the time code provided from the time server 141. The first object generation device 114 generates a 3D model of the subject present in the shooting region through the volumetric capture method and outputs the 3D model in combination with the time code to the storage device 142. The 3D model here is a shape model in which a texture that is based on the shot image is applied to the surface of three-dimensional shape data formed through the volumetric capture method. Note that the volumetric capture system 101 may have a configuration different from that illustrated in FIG. 1. For example, the cameras 112-1 to 112-12 may be connected directly to the first object generation device 114, and the time code may be provided directly to the first object generation device 114 from the time server 141. The cameras 112-1 to 112-12 may also be daisy-chained. The time server 141 may also input the time code to the cameras 112-1 to 112-12, and the cameras 112-1 to 112-12 may output the 2D images along with the time code. The first object generation device 114 may also be constituted by a plurality of devices.

The motion capture system 121 includes a sensor group 131 including sensors 132-1 to 132-6, a hub 133, and a second object generation device 134. The sensors 132-1 to 132-6 belonging to the sensor group 131 are arranged so as to surround the subject, and the two-dimensional position of a marker attached to the subject is identified (calculated) through shooting using infrared light. The two-dimensional position of the marker identified by each of the plurality of sensors 132-1 to 132-6 is provided to the second object generation device 134 via the hub 113 along with the time code provided from the time server 141. The second object generation device 134 calculates the three-dimensional position of the marker on the basis of the information of the two-dimensional position of the marker obtained from each of the sensors 132-1 to 132-6 using the motion capture method, and obtains posture information of the subject. The second object generation device 134 then generates a bone model of the subject using the information that has been calculated and obtained. The second object generation device 134 generates a 3D model by aligning a predetermined CG model to the bone model, and outputs position information of the 3D model in combination with the time code to the storage device 142. Note that the motion capture system 121 may have a configuration different from that illustrated in FIG. 1. For example, the sensors 132-1 to 132-6 may be connected directly to the second object generation device 134, and the time code may be provided directly to the second object generation device 134 from the time server 141. The sensors 132-1 to 132-6 may also be daisy-chained. The time server 141 may also input the time code to the sensors 132-1 to 132-6, and the sensors 132-1 to 132-6 may output the two-dimensional position information of the marker along with the time code. The second object generation device 134 may also be constituted by a plurality of devices.

In the present embodiment, the respective systems are calibrated such that a spatial coordinate system used in the volumetric capture system 101 and a spatial coordinate system used in the motion capture system 121 coincide. For example, it is assumed that in the volumetric capture system 101, the coordinates of a specific point are expressed as (Xv, Yv, Zv), and in the motion capture system 121, the coordinates of that specific point are expressed as (Xm, Ym, Zm). In this case, if Xv=Xm, Yv=Ym, and Zv=Zm, the real-space positions of that specific point indicated in both systems coincide. The calibration is performed such that the coordinates match for all points in at least the shooting region. Although it is assumed here that the spatial coordinate systems are calibrated to coincide in both systems, this is not absolutely necessary, and the spatial coordinates of one system may be converted into coordinate values of the spatial coordinate system of the other system.

The rendering device 143 is an image generation device that generates a virtual viewpoint image using a 3D model stored in the storage device 142 in accordance with a position and direction of a virtual viewpoint set through a UI unit (not shown) operated by a user viewing the virtual viewpoint image. “UI” is an acronym for “user interface”. The UI unit includes an operation unit such as a mouse, a keyboard, operation buttons, a touch panel, and the like, and accepts operations made by a user. The rendering device 143 generates the virtual viewpoint image representing the appearance from the virtual viewpoint by arranging the 3D model obtained from the storage device 142 in the virtual space and rendering that 3D model in accordance with the viewpoint position and direction of a virtual camera. In other words, a virtual viewpoint image is generated which reproduces a scene observed by the virtual camera when the virtual camera is set at a specific viewpoint position to face the virtual space in which the 3D model is arranged. The virtual viewpoint image in the present embodiment includes a desired viewpoint image (virtual viewpoint image) corresponding to a viewpoint and a gaze direction specified by a user as desired. In addition, the virtual viewpoint image in the present embodiment may include an image corresponding to a viewpoint and a gaze direction specified by the user from among a plurality of candidates for viewpoints and gaze directions, an image corresponding to a viewpoint and a gaze direction automatically specified by the device, or the like. The rendering device 143 provides the generated virtual viewpoint image to the information display device 144, and the information display device 144 obtains and displays the virtual viewpoint image generated by the rendering device 143. Note that this is merely one example, and for example, the rendering device 143 may store the virtual viewpoint image in the storage device 142, and the information display device 144 may perform control to read out the virtual viewpoint image from the storage device 142 and display the virtual viewpoint image.

Although the present embodiment describes an example in which the 3D model is generated through both the volumetric capture and motion capture methods, the configuration is not limited thereto. That is, the following descriptions can be applied in a system that generates the respective 3D models using two or more of any methods capable of generating a 3D model.

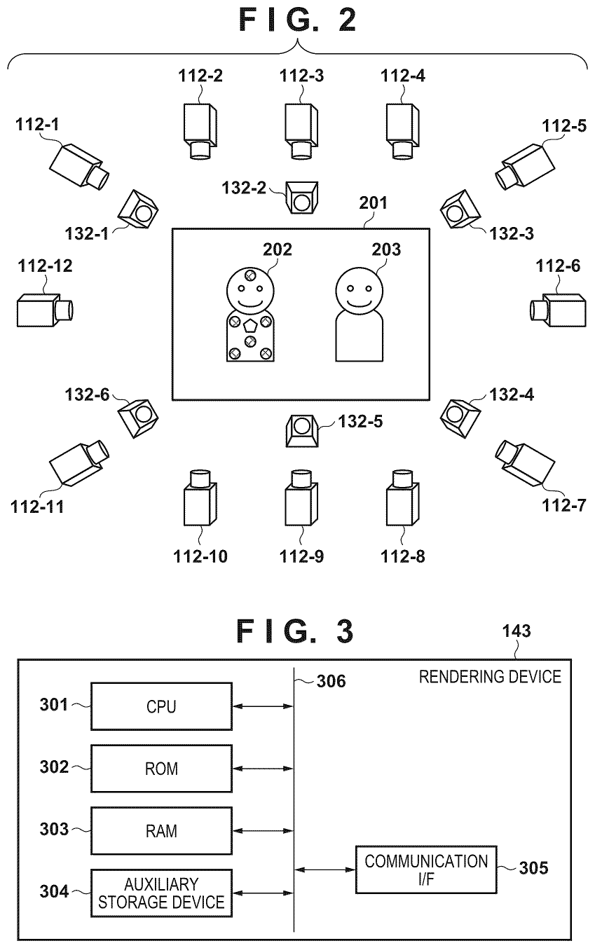

FIG. 2 illustrates an example of the arrangement of the cameras 112-1 to 112-12 and the sensors 132-1 to 132-6.

In FIG. 2, the 12 cameras 112-1 to 112-12 are disposed so as to surround a shooting region 201 to be shot. The cameras 112-1 to 112-12 shoot the shooting region 201 from mutually-different directions to generate a virtual viewpoint image through volumetric capture, and output the shot image. The cameras 112-1 to 112-12 may be digital cameras, for example, and may be cameras that shoot still images, cameras that shoot moving images, or cameras that shoot both still images and moving images. In the present embodiment and the appended claims, the term “image” is used to include both still images and moving images, unless otherwise specified. Note also that in the present embodiment, an image capturing device that combines an image capturing unit having an image sensor and a lens that focuses light rays onto the image sensor is called a “camera”. The volumetric capture system 101 is configured to generate a virtual viewpoint image in the shooting region 201 using an image captured using a plurality of cameras included in the camera group 111 (the cameras 112-1 to 112-12). Although the present embodiment describes an example in which 12 cameras are provided, the number of cameras may be any number greater than 1. Additionally, although FIG. 2 illustrates an example in which the cameras 112-1 to 112-12 surround the shooting region 201 from all directions, the configuration is not limited thereto. For example, the cameras may be arranged only in a set angle range centered on a point within the shooting region 201.

In FIG. 2, the six sensors 132-1 to 132-6 are arranged so as to surround the shooting region 201. The sensors 132-1 to 132-6 shoot the shooting region 201 from mutually-different directions to generate a bone model through motion capture, and obtain the two-dimensional coordinates of a marker attached to the subject as motion data. The motion capture system 121 is configured to generate a bone model of a specific subject present in the shooting region 201 using the images captured using the plurality of sensors included in the sensor group 131 (the sensors 132-1 to 132-6). Note that the “shooting” by the sensor can be performed in any format as long as the position of the marker attached to the surface of the subject can be detected. For example, the configuration may be such that an invisible marker is detected using an infrared sensor, or such that a visible marker is detected using a camera. Additionally, although the present embodiment describes an example in which six sensors are provided so as to surround the subject, the number of sensors may be any number greater than 1. Furthermore, although FIG. 2 illustrates an example in which the sensors 132-1 to 132-6 surround the shooting region 201 from all directions, the configuration is not limited thereto. For example, the sensors may be arranged only in a set angle range centered on a point within the shooting region 201.

Note that the volumetric capture system 101 may be used to generate the bone model, without using the motion capture system 121. For example, a known method can be used which uses silhouette data extracted having separated a foreground region, which is a subject part, and a background, which is a part other than the foreground region, from the shot images obtained by the cameras 112-1 to 112-12, and an initial posture model using the bones. For example, the initial posture model is projected onto a selected shot image as a temporary shape model, and a degree of similarity between the projected region and the silhouette data is evaluated. At this time, the degree of similarity increases as the shape (silhouette) of the foreground region corresponding to the posture of the subject becomes more similar to the initial posture of the bones, and the degree of similarity decreases when the shape of the foreground region becomes less similar to the initial posture of the bones. Next, the initial posture model is deformed to update the temporary shape model, and the degree of similarity between the region where the shape model is projected onto the shot image and the silhouette is evaluated again. In this manner, the degree of similarity between the region where the shape model is projected onto the shot image and the silhouette is repeatedly evaluated while updating the temporary shape model. Then, for example, the bones corresponding to the shape model having the highest degree of similarity can be output as a bone model corresponding to that shot image. Note that when updating the shape model and evaluating the degree of similarity, the bones corresponding to the shape model whose degree of similarity exceeds a predetermined value for the first time may be output as the bone model corresponding to that shot image. Note also that when a subject which moves continuously is being shot, it is possible to use, as the stated initial posture model used to evaluate the degree of similarity in a specific frame, a shape model evaluated as having a degree of similarity that is the highest or that exceeds a predetermined value with respect to the shot image in the previous frame.

Three-dimensional posture estimation information may also be specified (calculated) by combining (i) two-dimensional posture estimation information of the shot images from all the cameras, obtained through two-dimensional posture estimation from the shot image obtained from each camera, and (ii) camera parameters of all the cameras. In this case, the bone model is generated on the basis of the three-dimensional posture estimation information.

The bone model may also be generated using a three-dimensional shape generated by the volumetric capture system 101. For example, artificial intelligence (AI) can be used to estimate 17 parts (bones) that form the human skeleton from a three-dimensional shape. In one example, the three-dimensional shape data can be generated by using the volumetric capture method to shoot a subject for which correct data of the bone model is present, and machine learning can be performed by taking that three-dimensional shape data as input data and the correct data of the bone model as labeled data. In this case, after a trained model is obtained through the machine learning, the three-dimensional shape of the subject obtained through the volumetric capture method is input to the trained model, and the bone model of the subject is output. The 17 bones described above are constituted by the following parts: the waist, the lower abdomen, the upper abdomen, the neck, the head, the right upper arm, the left upper arm, the right forearm, the left forearm, the right hand, the left hand, the right thigh, the left thigh, the right shin, the left shin, the right foot, and the left foot. However, the parts of the person are not limited thereto, and bones defined in more or less detail may be used.

In FIG. 2, a subject 202 is a subject for which a 3D model is to be generated by the motion capture system 121, and a marker for detecting a position in the motion capture is attached to the surface of the subject 202. A subject 203 is a subject for which a 3D model is to be generated by the volumetric capture system 101. Here, a 3D model is also generated for the subject 202 in the volumetric capture system 101. However, in the final image after rendering, the 3D model generated through the motion capture method is used for the subject 202, and the 3D model generated by the volumetric capture method is not used. This processing will be described later.

### Device Configuration

FIG. 3 is a diagram illustrating an example of the hardware configuration of the rendering device 143. The rendering device 143 includes, for example, a CPU 301, a ROM 302, a RAM 303, an auxiliary storage device 304, a communication I/F 305, and a bus 306. Note that “CPU” is an acronym of “Central Processing Unit”, “ROM” is an acronym of “Read-Only Memory”, and “RAM” is an acronym of “Random Access Memory”. “I/F” is an abbreviation for “interface”. Furthermore, other devices in the image generation system, such as the first object generation device 114 and the second object generation device 134, may also have the same hardware configuration as that in FIG. 3.

The CPU 301 is a processor that controls the rendering device 143 as a whole using computer programs, data, and the like stored in one or more memories, such as the ROM 302, the RAM 303, and the like. Note that the rendering device 143 may have one or more dedicated pieces of hardware different from the CPU 301, and at least some of the processing performed by the CPU 301 may be performed by the dedicated hardware. The dedicated hardware includes, for example, an application-specific integrated circuit (ASIC), a field-programmable gate array (FPGA), a digital signal processor (DSP), and the like. The CPU 301 is an example of a processor, and the rendering device 143 may be configured to include one or more of any desired type of processor, such as a microprocessing unit (MPU). The ROM 302 stores programs, parameters, and the like that need not be changed. The RAM 303 temporarily stores programs, data, and the like supplied from the auxiliary storage device 304, data supplied from the exterior through the communication I/F 305, and the like. The ROM 302 and the RAM 303 are examples of memories, and the rendering device 143 may be configured to include one or more of any desired type of memory. The auxiliary storage device 304 is configured including a hard disk drive or the like, for example, and stores various types of content data such as images, audio, and the like. The communication I/F 305 is used for communicating with external devices such as the camera group 111 and the like. For example, if the rendering device 143 is connected to external devices by wires, cables for communication are connected to the communication I/F 305. If the rendering device 143 has a function for communicating wirelessly with external devices, the communication I/F 305 includes an antenna. The bus 306 communicates information by connecting the various parts of the rendering device 143. Note that if the rendering device 143 has an internal UI unit, the rendering device 143 includes a display unit, an operation unit, and the like in addition to the configuration illustrated in FIG. 3.

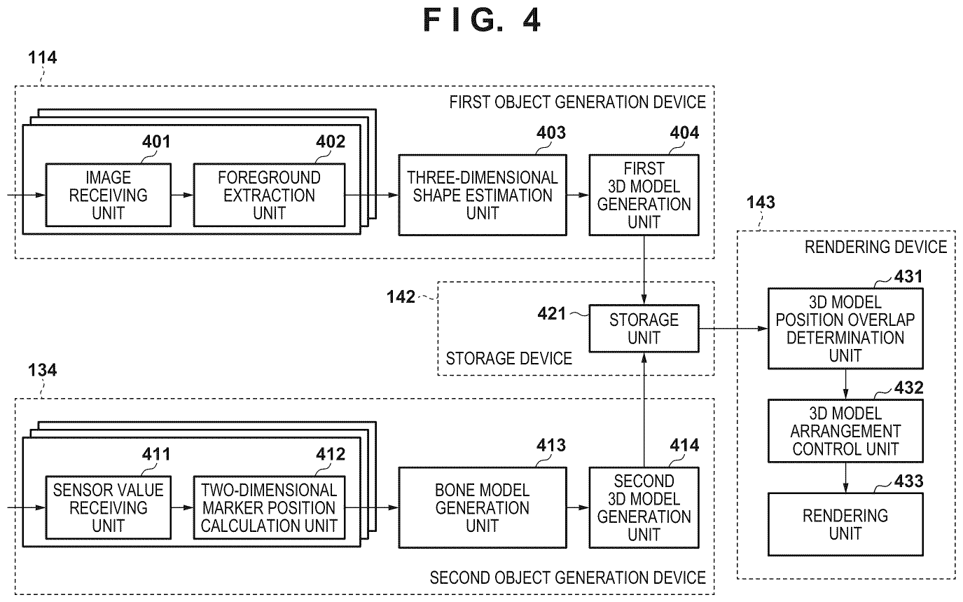

FIG. 4 illustrates an example of the functional configurations of the first object generation device 114, the second object generation device 134, and the rendering device 143 in the image generation system. The first object generation device 114 includes an image receiving unit 401 and a foreground extraction unit 402 for each camera, for example. The first object generation device 114 also includes a three-dimensional shape estimation unit 403 and a first 3D model generation unit 404. The second object generation device 134 includes a sensor value receiving unit 411 and a two-dimensional marker position calculation unit 412 for each sensor, for example. The second object generation device 134 also includes a bone model generation unit 413 and a second 3D model generation unit 414. The storage device 142 includes a storage unit 421, for example. The rendering device 143 includes a 3D model position overlap determination unit 431, a 3D model arrangement control unit 432, and a rendering unit 433, for example. Each of the functions can be implemented, for example, by the CPU 301 executing a program stored in the ROM 302, the auxiliary storage device 304, or the like. Additionally, at least some of the functions may be implemented by dedicated hardware.

The image receiving unit 401 receives shot images obtained from shooting performed by each of the cameras 112-1 to 112-12. The image receiving unit 401 outputs the received shot images to the foreground extraction unit 402. The foreground extraction unit 402 generates a foreground image from each of the shot images obtained from the image receiving unit 401, and outputs the foreground image to the three-dimensional shape estimation unit 403. The foreground extraction unit 402 obtains the foreground image for each camera by, for example, holding an image in which the subject is not present in advance as a background image for each camera, and then extracting a foreground region using the difference between the image shot by the camera and the background image. The three-dimensional shape estimation unit 403 generates a three-dimensional shape of the subject included in this foreground part on the basis of the foreground image obtained on the basis of the shot images from the plurality of cameras, and outputs the three-dimensional shape to the first 3D model generation unit 404. The three-dimensional shape of the subject is generated by a shape estimation method such as the visual cone intersection method (Visual Hull), for example. Although the three-dimensional shape of the subject is, for example, three-dimensional shape data constituted by a point cloud, the three-dimensional shape is not limited thereto, and may be expressed in another form, such as by polygons, for example.

The first 3D model generation unit 404 generates a 3D model by adding texture data obtained from extraction the foreground region to the obtained three-dimensional shape. The first 3D model generation unit 404 then outputs a combination of the generated 3D model, information indicating the position of the 3D model, and the time code obtained from the time server 141 to the storage unit 421. A cuboid that circumscribes the shape of the 3D model is used as the information indicating the position of the 3D model. This cuboid will be called a “bounding box” hereinafter. The bounding box defines a region corresponding to the position in the virtual space in which the corresponding 3D model is to be arranged. The coordinates of each of the eight vertices of the bounding box are specified as follows, using maximum coordinate values (Xmax, Ymax, and Zmax) and minimum coordinate values (Xmin, Ymin, and Zmin) of each of the XYZ axes of the 3D model shape.
Vertex 1 (Xmin, Ymin, Zmin)
Vertex 2 (Xmax, Ymin, Zmin)
Vertex 3 (Xmin, Ymax, Zmin)
Vertex 4 (Xmax, Ymax, Zmin)
Vertex 5 (Xmin, Ymin, Zmax)
Vertex 6 (Xmax, Ymin, Zmax)
Vertex 7 (Xmin, Ymax, Zmax)
Vertex 8 (Xmax, Ymax, Zmax)

The sensor value receiving unit 411 receives an infrared light sensor value from each of the sensors 132-1 to 132-6 and outputs those values to the two-dimensional marker position calculation unit 412. The two-dimensional marker position calculation unit 412 calculates the two-dimensional position of the marker attached to the subject at the sensor position for each sensor on the basis of the corresponding infrared light sensor value obtained from the sensor value receiving unit 411, and outputs those two-dimensional positions to the bone model generation unit 413. The bone model generation unit 413 calculates the three-dimensional position of the marker and generates a bone model by combining the two-dimensional position information of the marker for each sensor with information on the positional relationship of each sensor obtained in advance through calibration. The bone model generation unit 413 outputs the generated bone model data to the second 3D model generation unit 414. The second 3D model generation unit 414 generates a 3D model by adding a CG model prepared in advance to the bone model data obtained from the bone model generation unit 413. The second 3D model generation unit 414 then outputs a combination of the generated 3D model, bounding box coordinates, which are information indicating the position of the 3D model, and the time code obtained from the time server 141 to the storage unit 421.

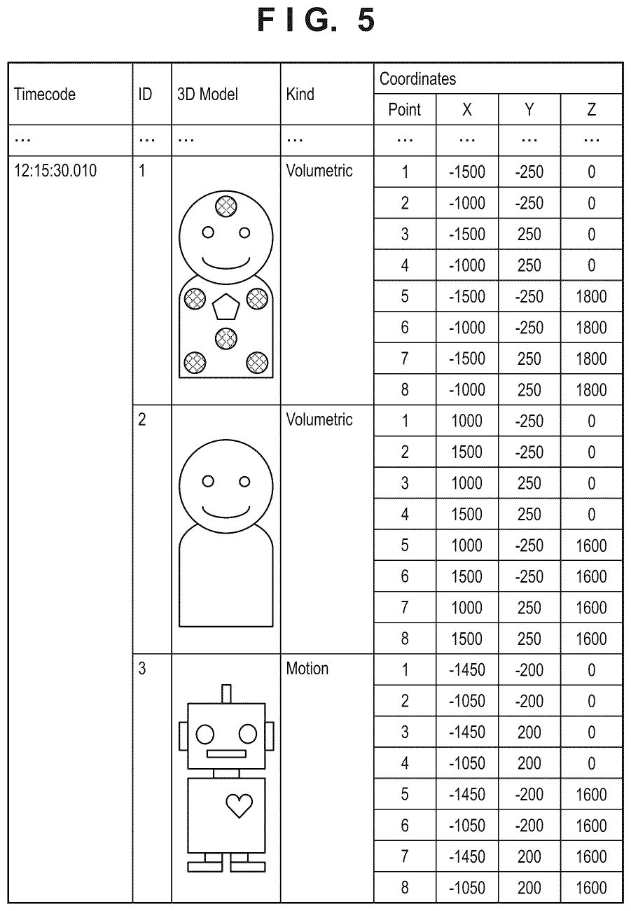

The storage unit 421 records the 3D model information obtained from the first 3D model generation unit 404 and the 3D model information obtained from the second 3D model generation unit 414, and manages this information in a 3D model database. Here, FIG. 5 illustrates an example of the data recorded in the storage unit 421 when the shooting of the subject 202 and the subject 203 illustrated in FIG. 2 is taken as an example. “Timecode” in FIG. 5 refers to the time code information output from the time server 141, and specifies the time in units of frames. For example, if one second's worth of data is recorded when the system is running at 60 frames per second (fps), separate time code information is held as the “time code” for each of the 60 frames corresponding to that one-second period. “ID” is identifier information that is numbered for each 3D model and used to designate the 3D model. “3D Model” is the generated 3D model data. “Kind” indicates the method (system) used to generate the 3D model. For a 3D model generated using the volumetric capture system 101, a value of “Volumetric” is held as the value of “Kind”. For a 3D model generated using the motion capture system 121, a value of “Motion” is held as the value of “Kind”. “Coordinates” indicates the spatial coordinates of the eight vertices of the bounding box corresponding to the 3D model. The storage unit 421 manages the time code and the 3D model information in association with each other on a frame-by-frame basis in this manner.

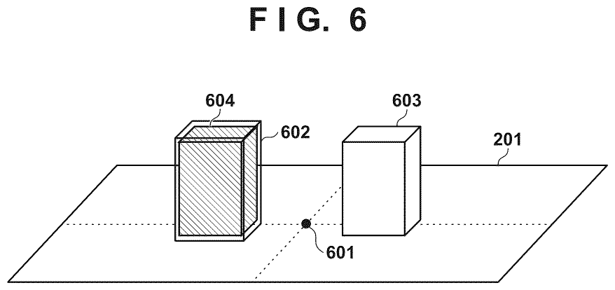

FIG. 6 schematically illustrates the position (and range), in the spatial coordinate system, of the bounding box of the 3D model for which “Timecode” corresponds to 12:15:30.010, among the data managed as illustrated in FIG. 5. Coordinates 601 are coordinates at the center of the shooting region 201 on a floor, and have world coordinate values (X, Y, Z)=(0, 0, 0), which is a reference position of the spatial coordinate system handled by the system. A bounding box 602 is a bounding box corresponding to the 3D model generated by shooting the subject 202 using the volumetric capture system 101. This bounding box is identified using the value of “Coordinates” corresponding to the ID of 1 in FIG. 5. A bounding box 603 is a bounding box corresponding to the 3D model generated by shooting the subject 203 using the volumetric capture system 101. This bounding box is identified using the value of “Coordinates” corresponding to the ID of 2 in FIG. 5. A bounding box 604 is a bounding box corresponding to the 3D model generated by shooting the subject 202 using the motion capture system 121. This bounding box is identified using the value of “Coordinates” corresponding to the ID of 3 in FIG. 5. As illustrated in FIG. 6, a 3D model of the subject 202 is generated using both the volumetric capture system 101 and the motion capture system 121. Because these 3D models are generated on the basis of the same subject 202, the corresponding bounding boxes (the bounding boxes corresponding to IDs of 1 and 3) overlap.

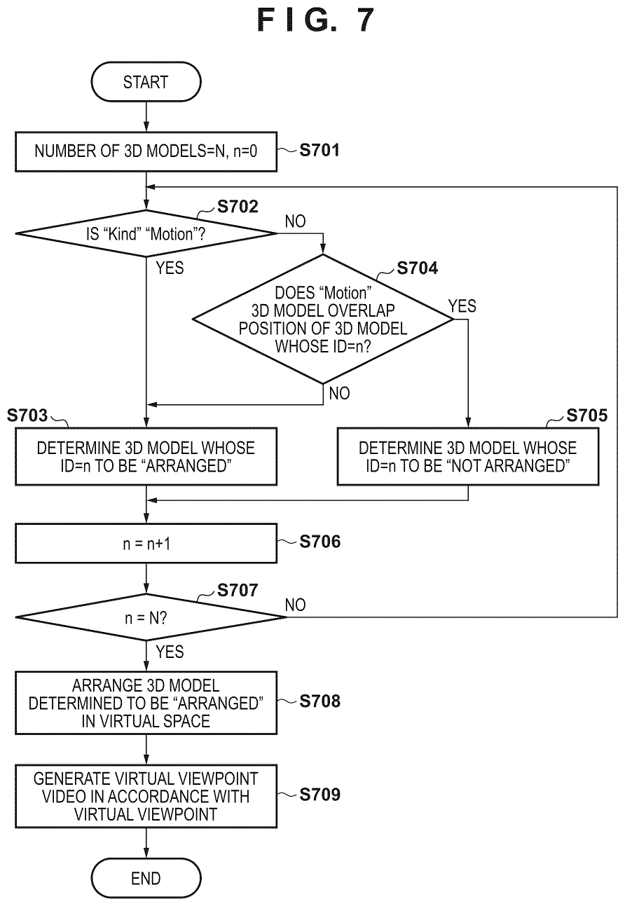

Returning to FIG. 4, the 3D model position overlap determination unit 431 obtains the information of the 3D model from the storage unit 421. The 3D model position overlap determination unit 431 then determines whether the 3D model generated by the motion capture system 121 and the 3D model generated by the volumetric capture system 101 overlap. Then, on the basis of the determination result, the 3D model position overlap determination unit 431 determines whether to arrange each 3D model in the virtual space. The determination as to whether the 3D models overlap is processing for identifying whether a 3D model generated on the basis of the same subject is present, and this processing will be described in detail later in the descriptions of the processing given with reference to FIG. 7. For example, as described above, for the subject 202, the 3D model generated by the motion capture system 121 and the 3D model generated by the volumetric capture system 101 overlap. In this case, the 3D model arrangement control unit 432 can determine not to arrange either the 3D model generated by the motion capture system 121 or the 3D model generated by the volumetric capture system 101 in the virtual space. For example, the 3D model arrangement control unit 432 can determine not to arrange the 3D model of the subject 202 generated by the volumetric capture system 101 in the virtual space.

The 3D model arrangement control unit 432 arranges the 3D model determined to be arranged by the 3D model position overlap determination unit 431 in the virtual space. However, the 3D model arrangement control unit 432 does not arrange the 3D model determined not to be arranged by the 3D model position overlap determination unit 431 in the virtual space. The virtual space for which a virtual viewpoint image is to be generated is configured by the 3D model arrangement control unit 432 arranging, for each time code, all of the 3D models stored in the storage unit 421 in association with that time code. The rendering unit 433 renders the virtual viewpoint image according to the position and direction of a virtual viewpoint set by a user operation made through the UI unit (not shown) in the virtual space configured by the 3D model arrangement control unit 432.

### Flow of Processing

An example of the flow of processing for generating the virtual viewpoint image will be described next with reference to FIG. 7. This processing is executed for each time code. An example will be described in which a 3D model generated using the motion capture system 121 is preferentially arranged in a virtual space in this processing. Note that this is merely an example, and the 3D model generated using the volumetric capture system 101 may be preferentially arranged instead. Which 3D model is to be arranged preferentially can be set as desired through a user operation, for example.

First, the 3D model position overlap determination unit 431 obtains the information of the 3D models from the storage unit 421, confirms the number of 3D models associated with the time code being processed, and executes initialization processing for performing the processing on the respective 3D models (step S701). Here, for example, the number of 3D models associated with the time code being processed is N, and a counter n for counting the 3D models that have been processed is set to 1.

The 3D model position overlap determination unit 431 then determines whether the “Kind” of the 3D model being processed (the 3D model having an ID of n) is “Motion” (step S702). If the “Kind” of the 3D model being processed is determined to be “Motion” (YES in step S702), the 3D model position overlap determination unit 431 determines to arrange the “3D model” in the virtual space (step S703). In other words, in the present embodiment, the 3D model generated using the motion capture system 121 is preferentially arranged, and thus if the “Kind” of the 3D model being processed is “Motion”, that 3D model is determined to be arranged in the virtual space. On the other hand, if the “Kind” of the 3D model being processed is “Volumetric” (NO in step S702), the 3D model position overlap determination unit 431 determines whether another 3D model having a “Kind” of “Motion” is present at a position overlapping the 3D model being processed (step S704). Then, if the 3D model position overlap determination unit 431 determines that another 3D model having a “Kind” of “Motion” is present at a position overlapping the 3D model being processed (YES in step S704), it is determined that the 3D model being processed is not to be arranged in the virtual space (step S705). In other words, if another 3D model is preferentially arranged in the virtual space, the “Volumetric” 3D model present at a position overlapping that 3D model is not arranged in the virtual space. On the other hand, if the 3D model position overlap determination unit 431 determines that another 3D model having a “Kind” of “Motion” is not present at a position overlapping the 3D model being processed (NO in step S704), it is determined that the 3D model being processed is to be arranged in the virtual space (step S705).

An example of a method for determining whether the 3D model being processed and another 3D model overlap will be described here. First, it is determined whether a 3D model corresponding to a given bounding box, generated by the volumetric capture system 101, overlaps with the bounding box of a 3D model generated by the motion capture system 121. For example, it is determined whether at least one vertex of the bounding box of the 3D model generated by the volumetric capture system 101 is present inside the bounding box of the 3D model generated by the motion capture system 121. If such a vertex is present, the bounding boxes are determined to overlap. If the bounding boxes overlap in this manner, the degree of overlap is then evaluated. In this evaluation, of the overlapping bounding boxes, a total volume amount Vall of the bounding box having the smaller volume and a volume amount Vlap of the spatial region overlapping therewith are specified, and the degree of overlap is expressed by a value Vlap/Vall indicating the percentage of the overlapping region. For example, if this value exceeds a predetermined level, the 3D model being processed and the other 3D model can be determined to overlap. The predetermined level can be, for example, 0.8 (80%). According to such a determination, if the two bounding boxes overlap only in a small part of the spatial region, the 3D models corresponding to those bounding boxes are not determined to overlap, and both the 3D models can be arranged in the virtual space. It is also conceivable that, for example, the two bounding boxes that are based on the results of shooting the same subject overlap sufficiently, and thus only one of the two 3D models corresponding to those bounding boxes can be arranged in the virtual space.

Note that even if a plurality of 3D models are generated on the basis of the same subject, the degree of overlap described above may not be 1 (100%) due to the shape of the 3D model. For example, if a pre-prepared CG model used when generating the 3D model using the motion capture system 121 is carrying an object on its back or holding an object in its hand, the bounding box is generated also taking that object into account. In contrast, if the subject shot for generating the 3D model is not carrying that object, the object is not reflected in the 3D model generated using the volumetric capture system 101. Accordingly, the bounding box of the 3D model generated using the motion capture system 121 is specified as being larger than the bounding box corresponding to the volumetric capture system 101 by an amount corresponding to that object. On the other hand, for example, the CG model used when generating a 3D model using the motion capture system 121 can be smaller than the actual subject. In this case, it is assumed that a first bounding box corresponding to the motion capture system 121 is smaller than a second bounding box corresponding to the volumetric capture system 101. Here, most of the first bounding box is present within the second bounding box, but if an object is present as described above, the first bounding box may not overlap with the second bounding box. In such a case, using the above-described predetermined level makes it possible to arrange only one of the plurality of 3D models in the virtual space, in consideration of the mismatch between the bounding boxes due to the shapes of the 3D models.

Although the predetermined level is 0.8 in the example described above, the level is not limited thereto. For example, the predetermined level may be determined on the basis of the shape of the 3D model generated by the motion capture system 121. For example, in the example illustrated in FIG. 5, the height (the length in the Z-axis direction) of the 3D model having an ID of 1 is 1800, as indicated by the Z value in “Coordinates”, whereas the height of the 3D model having an ID of 3 is 1600 (the unit can be millimeters, for example). In addition, the X and Y values of “Coordinates” vary depending on the puffiness of the clothing of the 3D model, the weight of the 3D model, and the like. In this manner, the size of the bounding box varies depending on the shape of the CG model used in the motion capture system 121. The degree of overlap between the bounding boxes also varies when the 3D models generated by the volumetric capture system 101 and the motion capture system 121 are arranged at exactly the same position. Accordingly, determining the predetermined level in accordance with the shape of the CG model used in the motion capture system 121 makes it possible to appropriately determine whether the plurality of 3D models are related to the same subject.

When determining whether to arrange the 3D model being processed in the virtual space, the 3D model position overlap determination unit 431 increments the counter n in order to change the 3D model being processed (step S706). Then, for all the 3D models, the 3D model position overlap determination unit 431 determines whether the processing of steps S702 to S705 is complete, i.e., whether the counter n has reached N+1 (step S707). If the counter n has not reached N+1 (NO in step S707), an unprocessed 3D model remains, and thus the 3D model position overlap determination unit 431 returns the sequence to step S702. On the other hand, if the counter n has reached N+1 (YES in step S707), the 3D model position overlap determination unit 431 moves the sequence to step S708. In step S708, the 3D model arrangement control unit 432 arranges, in the virtual space, the 3D model determined to be arranged. The rendering unit 433 then generates a virtual viewpoint image, which is an image corresponding to observing the virtual space from the position and direction of the virtual viewpoint that has been set (step S709), and the sequence then ends.

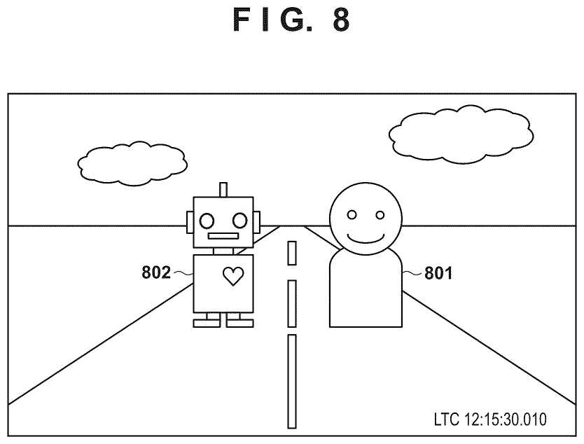

FIG. 8 illustrates an example of a virtual viewpoint image generated in this manner. FIG. 8 illustrates an example of a virtual viewpoint image generated using one frame corresponding to a time code of 12:15:30.010, among the data illustrated in FIG. 5. An object 801 is obtained by rendering the 3D model stored corresponding to the ID of 2 in FIG. 5. This 3D model is arranged in the virtual space as a result of determining that the 3D model has a “Kind” of “Volumetric” but does not overlap with the 3D model having a “Kind” of “Motion” in the determination of step S704. An object 802 is obtained by rendering the 3D model stored corresponding to the ID of 3 in FIG. 5. Because the “Kind” is “Motion”, this 3D model is arranged in the virtual space through the determination of step S702. On the other hand, for the 3D model stored in association with the ID of 1 in FIG. 5, “Kind” is “Volumetric”, and that 3D model is also determined in step S704 to overlap with the 3D model having an ID of 3, for which “Kind” is “Motion”. As such, that 3D model is not arranged in the virtual space. As a result, the object corresponding to this 3D model is not displayed in the virtual viewpoint image.

As described above, in the present embodiment, a plurality of subjects in a common shooting space are shot using different methods, and a virtual viewpoint image is generated having arranged 3D models generated by corresponding systems in a single virtual space. A plurality of subjects present in a common space move in tandem while recognizing each other's existence, and thus by performing shooting corresponding to different methods for generating 3D models in the common space, the corresponding 3D models also move in tandem with each other. As a result, even if a plurality of 3D models are generated by mutually-independent systems, it is possible to generate a virtual viewpoint image in which the plurality of 3D models are arranged in a virtual space without a sense of unnaturalness. At this time, for a subject for which a 3D model is to be generated through a plurality of methods, only one of the plurality of 3D models corresponding to that subject is displayed, and the other 3D models among the plurality of 3D models are not arranged in the virtual space. Through this, a plurality of 3D models generated from a common subject can be prevented from being arranged in the virtual space in an overlapping manner. This makes it possible to reduce a sense of unnaturalness in the virtual viewpoint image that is output.

### Variation

When an anomaly occurs when generating a 3D model using the motion capture system 121, an event can occur where, for example, a virtual 3D model disappears and a 3D model of a real subject generated using the volumetric capture system 101 appears. The present variation will describe a control method for preventing an inappropriate virtual viewpoint image resulting from such an event from being output.

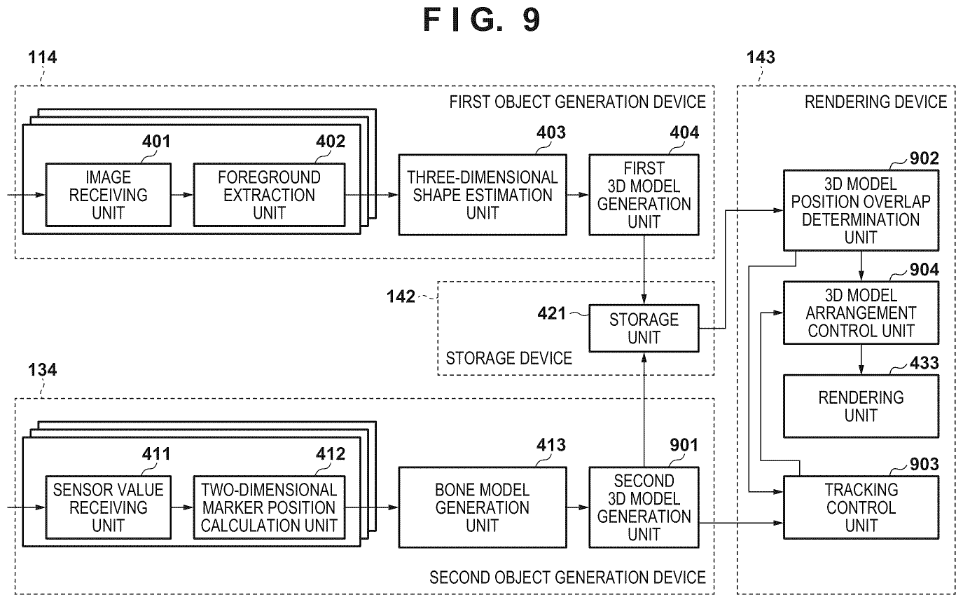

FIG. 9 illustrates an example of the functional configurations of the first object generation device 114, the second object generation device 134, and the rendering device 143 in the image generation system according to the present variation. Of the configuration illustrated in FIG. 9, functions having the same functions as in FIG. 4 will be given the same reference numerals as in FIG. 4, and will not be described in detail.

A second 3D model generation unit 901 in the present variation generates a 3D model on the basis of the bone model data obtained from the bone model generation unit 413, in the same manner as in the case of FIG. 4. Then, if a 3D model has been generated, the second 3D model generation unit 901 then outputs a combination of that 3D model, bounding box coordinates, which are information indicating the position of the 3D model, and the time code obtained from the time server 141 to the storage unit 421. On the other hand, if a 3D model has not been generated, the second 3D model generation unit 901 outputs non-generation information indicating that a 3D model has not been generated to a tracking control unit 903. For example, if a performer corresponding to the 3D model generated using the motion capture system 121 is no longer present in the shooting region 201, a 3D model is not generated. Furthermore, if a performer is present in the shooting region 201 but information necessary for generating the 3D model has not been input to the second 3D model generation unit 901 due to some anomaly, such as sensor failure or a data transmission path bring cut off, the 3D model will not be generated.

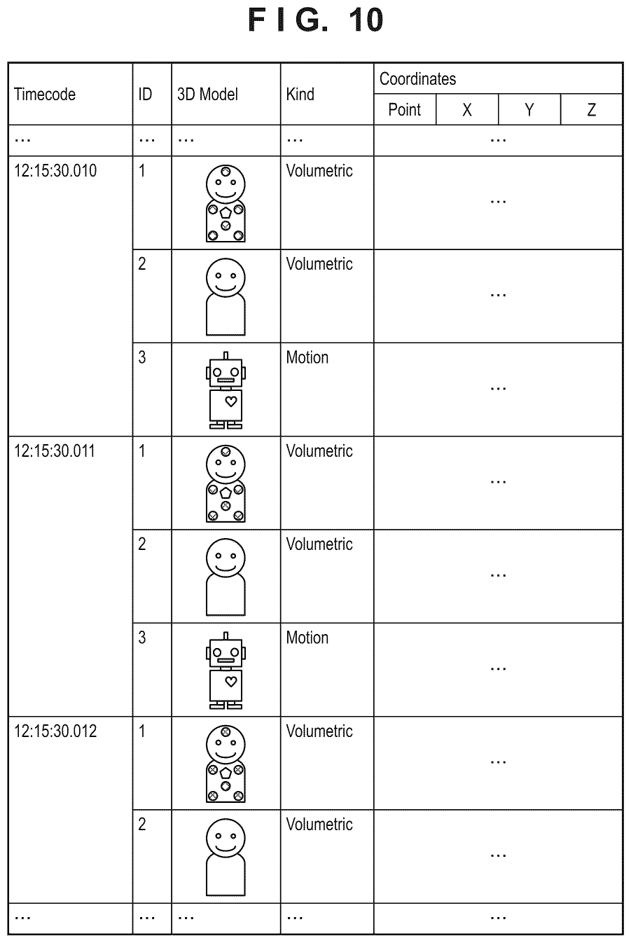

Here, an example of the data recorded in the storage unit 421 when the subject 202 and the subject 203 illustrated in FIG. 2 are shot is illustrated in FIG. 10. When “Timecode” is 12:15:30.011, a 3D model having an ID of 3, for which “Kind” is “Motion”, is recorded. However, when “Timecode” is 12:15:30.012, a 3D model having an ID of 3 is not recorded. In this case, for example, in the processing illustrated in FIG. 7, when “Timecode” is 12:15:30.012, a 3D model having an ID of 1 is arranged in the virtual space instead of the 3D model having an ID of 3. However, if such a 3D model is displayed, the display changes from a virtual model to a real model, which can cause a sense of unnaturalness. Accordingly, in the present variation, processing is performed to prevent such a 3D model corresponding to a real subject from being arranged in the virtual space.

When this 3D model is no longer generated, the second 3D model generation unit 901 outputs the non-generation information of the 3D model to the tracking control unit 903. A 3D model position overlap determination unit 902 obtains the information of the 3D model from the storage unit 421, and determines whether to arrange the 3D model in the virtual space by determining the overlap as described above. The 3D model position overlap determination unit 902 outputs information indicating whether to arrange the 3D model in the virtual space to the tracking control unit 903 and a 3D model arrangement control unit 904. If a notification indicating the non-generation information of the 3D model has been received from the second 3D model generation unit 901, the tracking control unit 903 determines the 3D model to be tracked and tracks the 3D model. The tracking control unit 903 outputs information indicating the tracking state, such as whether tracking is being performed, to 3D model arrangement control unit 904. Here, the 3D model to be tracked is the 3D model generated by the volumetric capture system 101, for the subject for which the 3D model is generated using the motion capture system 121. In other words, the 3D model not arranged in the virtual space when a 3D model generated by the motion capture system 121 is present is the 3D model to be tracked. The 3D model arrangement control unit 904 performs processing for arranging the 3D model in the virtual space on the basis of information indicating whether to arrange the 3D model determined by the 3D model position overlap determination unit 902 and information indicating the tracking state by the tracking control unit 903.

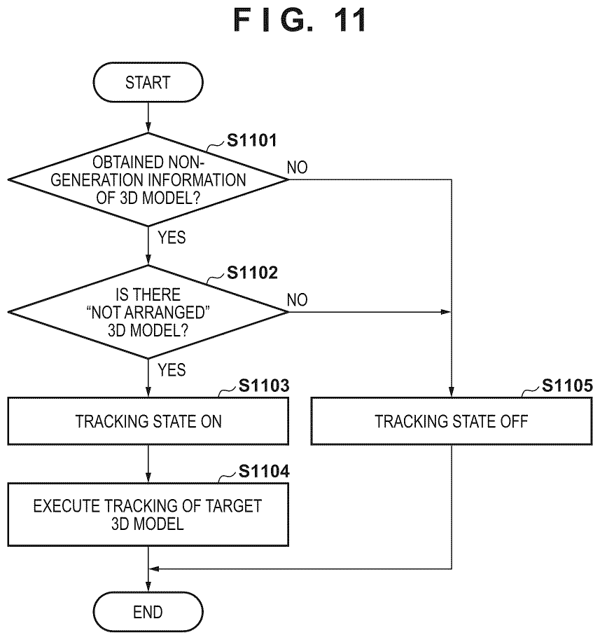

An example of the flow of processing executed by the tracking control unit 903 will be described here with reference to FIG. 11. The tracking control unit 903 determines whether non-generation information of the 3D model has been obtained from the second 3D model generation unit 901 (step S1101). Then, if the non-generation information of the 3D model has not been obtained (NO in step S1101), the tracking control unit 903 sets the tracking state to OFF (step S1105), after which the processing ends. However, if the non-generation information of the 3D model has been obtained (YES in step S1101), the tracking control unit 903 determines whether the 3D model determined not to be arranged by the 3D model position overlap determination unit 902 is present (step S1102). For example, the tracking control unit 903 determines whether a 3D model determined not to be arranged is present in the frame previous to the frame in which the non-generation information of the 3D model was obtained for the first time. The 3D model position overlap determination unit 902 can determine to arrange the 3D model generated by the volumetric capture system 101 at the point in time when the 3D model generated by the motion capture system 121 is no longer present. As such, whether a 3D model determined not to be arranged is present can be determined not in the frame serving as a trigger for obtaining the non-generation information of the 3D model, but rather in the previous frame thereto. It is assumed that at the timing at which the non-generation information of the 3D model is output by the second 3D model generation unit 901, due to processing delay or the like, the 3D model position overlap determination unit 902 is processing a frame from a timing prior to the frame in which the 3D model is not generated. In this case, the tracking control unit 903 may confirm whether the 3D model determined not to be arranged by the 3D model position overlap determination unit 902 is present at the timing when the non-generation information is obtained.

If the tracking control unit 903 determines that the 3D model determined not to be arranged is not present (NO in step S1102), the tracking state is set to OFF (step S1105), and the processing ends. However, if the tracking control unit 903 determines that the 3D model determined not to be arranged is present (YES in step S1102), the tracking state is set to ON (step S1103). The tracking control unit 903 then tracks the 3D model determined not to be arranged (step S1104). Note that the tracking control unit 903 can execute the processing illustrated in FIG. 11 for each frame, for example. Then, if a notification indicating the non-generation information of the 3D model is detected as no longer being obtained from the second 3D model generation unit 901, the tracking control unit 903 sets the tracking state to OFF and stops the tracking processing.

An example of the flow of processing for generating the virtual viewpoint image will be described next with reference to FIG. 12. In this processing, step S1201, which is based on tracking, is performed after determining whether to arrange the 3D model in the virtual space according to whether the 3D model overlaps with another 3D model, for all the 3D models corresponding to the frame to be processed, in the processing illustrated in FIG. 7. Steps in which processing similar to that illustrated in FIG. 7 is performed will be given the same reference signs and will not be described. In step S1201, the 3D model arrangement control unit 904 determines not to arrange the 3D model to be tracked, if the tracking state is ON. For example, in the processing of FIG. 7, the 3D model having an ID of 1 is determined to be arranged in the virtual space when the 3D model having an ID of 3, illustrated in FIG. 10, is not present, but in the present variation, that 3D model is being tracked and is therefore not arranged in the virtual space. In other words, when “Timecode” is 12:15:30.011, the 3D model having an ID of 1 and the 3D model having an ID of 3 are overlapping, and thus the 3D model position overlap determination unit 902 determines not to arrange the 3D model having an ID of 1. On the other hand, when the non-generation information of the 3D model at the point in time when “Timecode” corresponding to the next frame is 12:15:30.012 is obtained from the second 3D model generation unit 901, the tracking control unit 903 tracks the 3D model having an ID of 1. The 3D model arrangement control unit 904 then determines not to arrange the 3D model having an ID of 1, which is being tracked, in the virtual space. In this manner, if the 3D model having an ID of 1 is present but the 3D model having an ID of 3 is not present, which can be assumed to be due to a failure to generate the 3D model through the motion capture method, the 3D model having an ID of 1 is not arranged in the virtual space. Note that when the 3D model having an ID of 3 is not present and the 3D model having an ID of 1 is also not present, the subject for which those 3D models is to be generated is not present in the shooting region 201. Accordingly, the 3D model corresponding to the subject is not arranged in the virtual space and is not displayed in the virtual viewpoint image, with no tracking being performed.

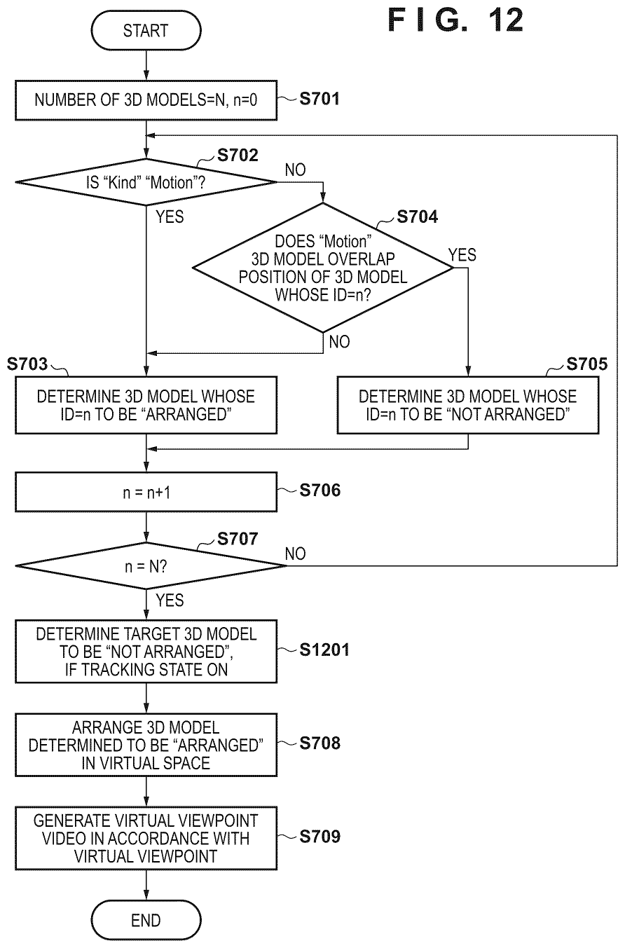

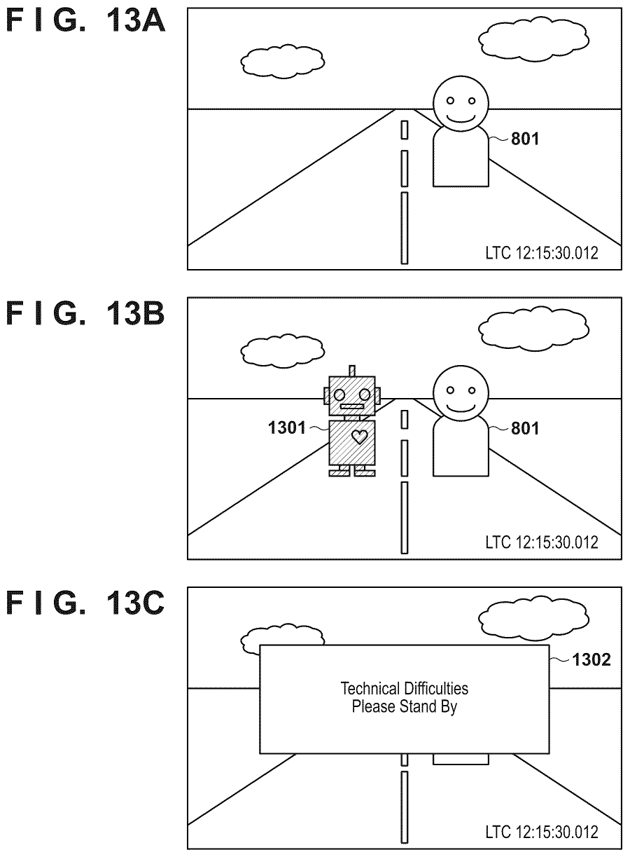

An example of a virtual viewpoint image generated using one frame corresponding to “Timecode” of 12:15:30.012 among the recorded data illustrated in FIG. 10 will be described next. Here, as described above, on the basis of the non-generation information of the 3D model having an ID of 3, the 3D model having an ID of 1 is subject to tracking, the 3D model having an ID of 1 is not arranged, and only the 3D model having an ID of 2 is arranged in the virtual space. FIG. 13A illustrates a virtual viewpoint image generated on the basis of this virtual space. In this manner, a situation where a virtual 3D model generated by the motion capture system 121 suddenly disappears and a real 3D model of the subject generated by the volumetric capture system 101 is displayed can be prevented.

The foregoing example describes processing in which when the 3D model having an ID of 3 is not generated, the 3D model having an ID of 1, which is the 3D model being tracked, is not arranged in the virtual space, and the object is not displayed in the virtual viewpoint image. However, this is merely an example, and the 3D model from the period where the model was correctly generated in the past may continue to be displayed in the virtual viewpoint image, as indicated by an object 1301 in FIG. 13B, for example. For example, the newest 3D model among the 3D models from the period when the 3D model was correctly generated (among the 3D models generated in the past) may continue to be displayed. In other words, the object 1301 corresponding to the 3D model having an ID of 3, from when “Timecode” is 12:15:30.011, may continue to be displayed. To make it possible to visibly confirm that the 3D model is not being generated, the object when the 3D model is being generated may be displayed in a different format from the object when the 3D model is not being generated, such as the hatched display illustrated in FIG. 13B. Furthermore, as illustrated in FIG. 13C, when it is detected that the 3D model has not been generated due to an anomaly in the motion capture system 121, information indicating to the user that an anomaly has occurred may be output overlaid on the virtual viewpoint, as indicated by a dialog 1302.

As described above, when an anomaly occurs in the generation of the 3D model by the motion capture system 121, a situation where the virtual 3D model suddenly disappears and the real 3D model of the volumetric capture system 101 appears can be prevented from arising. This makes it possible to prevent inappropriate virtual viewpoint images from being presented.

The foregoing describes an example in which the volumetric capture method and the motion capture method are used as the methods for generating the 3D models. This is merely an example, however, and other methods may be used to generate the 3D models. For example, when generating a first 3D model for all of the plurality of subjects using a first method and generating a second 3D model for some of the subjects using a second method, the virtual viewpoint image can be generated having preferentially arranged the second 3D model in the virtual space. Note that a 3D model may be generated for a first group of subjects present in the shooting region using the first method, and a 3D model may be generated for a second group of subjects present in the shooting region using the second method. Here, a 3D model for a third group of subjects belonging to both the first group and the second group can be generated using both the first method and the second method. In this case, a virtual viewpoint image that is based on the virtual space in which only the 3D model generated through one of the methods, of the 3D model corresponding to the first method and the 3D model corresponding to the second method, is arranged for the subject belonging to the third group, can be output. In this case, which method of 3D model is to be arranged in the virtual space may be determined in advance in the system, or may be determined by a user operation. Additionally, although the foregoing describes an example in which the 3D models are generated using two methods, the 3D models may be generated using three or more methods.

According to the present disclosure, a desired virtual viewpoint image can be generated while linking subjects sufficiently.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-023037, filed Feb. 19, 2024, which is hereby incorporated by reference herein in its entirety.

What is claimed is:

1. An image generation device comprising:
one or more processors; and
one or more memories that store a computer-readable instruction for causing, when executed by the one or more processors, the one or more processors to:
obtain (i) a plurality of first three-dimensional (3D) models, of corresponding ones of a plurality of subjects, generated through a first method on the basis of shooting a predetermined region in which the plurality of subjects are present, and (ii) a second 3D model that is based on posture information of a specific subject, among the plurality of subjects, present in the predetermined region during the shooting, the second 3D model corresponding to the specific subject and being generated through a second method different from the first method; and
output a virtual viewpoint image generated on the basis of (i) the first 3D model of a subject, among the plurality of subjects, that is different from the specific subject, and (ii) the second 3D model corresponding to the specific subject.

2. The image generation device according to claim 1,
wherein the virtual viewpoint image is generated without using the first 3D models of the specific subject, and is output.

3. The image generation device according to claim 1,
wherein the virtual viewpoint image is generated using the second 3D model corresponding to the specific subject instead of the first 3D models of the specific subject, and is output.

4. The image generation device according to claim 3,
wherein a position, in a virtual space, of the second 3D model corresponding to the specific subject is a position, in the virtual space, of the first 3D models of the specific subject.

5. The image generation device according to claim 1,
wherein in a case where, among a plurality of regions in which corresponding ones of the plurality of first 3D models corresponding to each of the plurality of subjects are present in a virtual space, a first region is present that overlaps by more than a predetermined level with a second region in which the second 3D model is present in the virtual space, the virtual viewpoint image is generated by arranging the second 3D model corresponding to the specific subject at a position of the first region instead of the first 3D model corresponding to the first region, and is output.

6. The image generation device according to claim 1,
wherein in a case where the second 3D model corresponding to the specific subject is not generated, the virtual viewpoint image is generated using the second 3D model corresponding to the specific subject generated in the past, and is output.

7. The image generation device according to claim 6,
wherein a display of the specific subject in the virtual viewpoint image generated using the second 3D model corresponding to the specific subject generated in the past is different from a display of the specific subject displayed in the virtual viewpoint image when the second 3D model is generated.

8. The image generation device according to claim 1,
wherein in a case where the second 3D model corresponding to the specific subject is not generated and the first 3D models of the specific subject are generated, information indicating an anomaly is output.

9. The image generation device according to claim 1,
wherein the first method is a volumetric capture method, and the second method is a motion capture method.

10. The image generation device according to claim 1,
wherein the first 3D models are generated by generating a three-dimensional shape of each of the plurality of subjects on the basis of shooting of the predetermined region by a plurality of cameras and then applying a texture obtained from the shooting to the three-dimensional shape.

11. The image generation device according to claim 9,
wherein the second 3D model is generated by generating a bone model of the specific subject from posture information that is based on information obtained from a plurality of sensors, and then deforming a computer graphics (CG) model to the bone model.

12. An image generation method executed by an image generation device, the method comprising:
obtaining (i) a plurality of first three-dimensional (3D) models, of corresponding ones of a plurality of subjects, generated through a first method on the basis of shooting a predetermined region in which the plurality of subjects are present, and (ii) a second 3D model that is based on posture information of a specific subject, among the plurality of subjects, present in the predetermined region during the shooting, the second 3D model corresponding to the specific subject and being generated through a second method different from the first method; and
outputting a virtual viewpoint image generated on the basis of (i) the first 3D model of a subject, among the plurality of subjects, that is different from the specific subject, and (ii) the second 3D model corresponding to the specific subject.

13. A non-transitory computer-readable storage medium that stores a program for causing a computer to:
obtain (i) a plurality of first three-dimensional (3D) models, of corresponding ones of a plurality of subjects, generated through a first method on the basis of shooting a predetermined region in which the plurality of subjects are present, and (ii) a second 3D model that is based on posture information of a specific subject, among the plurality of subjects, present in the predetermined region during the shooting, the second 3D model corresponding to the specific subject and being generated through a second method different from the first method; and
output a virtual viewpoint image generated on the basis of (i) the first 3D model of a subject, among the plurality of subjects, that is different from the specific subject, and (ii) the second 3D model corresponding to the specific subject.
